(19) United States
(12) Patent Application Publication
(10) Pub. No.: US 2020/0234345 A1
(43) Pub. Date: Jul. 23, 2020

(54) THIRD PARTY RISK MANAGEMENT SYSTEM PROVIDING SHARED ACCESS TO THIRD PARTY DATA

(71) Applicant: Blue Umbrella Limited, Siu Sai Wan (HK)

(72) Inventors: Allan Matheson, Vancouver (CA); Mariem Attia, Singapore (SG); Ramesh Bhagasra, Gurgaon (IN)

(21) Appl. No.: 16/250,813

(22) Filed: Jan. 17, 2019

(51) Int. Cl. G06Q 30/02; G06Q 20/12

(52) U.S. Cl. CPC G06Q 30/0282; G06Q 30/018; G06Q 20/123

(57) ABSTRACT

A computer-implemented method of managing third party risk comprises receiving, from a computing device, a request by a user for a questionnaire to be completed by a third party. The questionnaire is sent to the third party for completion and a completed questionnaire is received from the third party. The completed questionnaire is then sent to the user via the computing device. The user also receives a notification on the computing device if one or more answers provided by the third party in the questionnaire triggers a user-specific flag based on individual perception of risk.

### TECHNICAL FIELD

The present disclosure relates to a third party risk management system and, in particular, to a third party risk management system which allows members to share access to third party data.

### BACKGROUND

U.S. Pat. No. 6,356,909, which issued on Mar. 12, 2002 to Spencer, discloses an integrated web based system for generating electronic request for proposal (RFP) forms and responding to the generated RFPs over a secure communications network. Using a web site interface, the system enables users to request specific information for goods and services from specific vendors, automates the process of responding to the RFPs, and automates the process of reviewing, analyzing and presenting the results. Potential vendors are notified via e-mail when the RFP is completed, and have the option to respond to the RFP by using information stored in the associated online databases or by providing new information that is then stored in the online databases. The system remembers links from questions to all appropriate responses and prompts vendors to add them to their response form. Analysis on completed forms is automated and enables the users to evaluate RFPs.

U.S. Pat. No. 9,959,367, which issued on May 1, 2018 to Ghent, discloses a system for providing a third party centralized data hub. The system includes a server storing a database of sets of third party data, and the system includes a third party risk management module on the server maintaining the third party data. The system includes a first set of client devices communicatively linked with the server over a digital communications network and operable by data providers to provide and modify one of the sets of third party data. The system includes a second set of client devices linked with the server and operable by data consumers to access a subset of the sets of third party data. During operations, the risk management module monitors the third party data, identifies a modification, by one of the data providers, of one of the sets of third party data, and automatically generates and transmits an alert to the second set of client devices.

### SUMMARY

There is provided a computer-implemented method of managing third party risk, the method comprising receiving, from a user, a request to establish an electronic relationship with a first third party to evaluate risk presented by the first third party. Data corresponding to the request is provided to a server system. Possible matches between the first third party and a plurality of other third parties are received from the server system. Confirmation as to whether the first third party matches one of the other third parties is received from the user. A set of shared third party data provided by the first third party is received from the server system. The set of shared third party data provided by the first third party is selected by the server system to be delivered to the user only if the user confirms that the first third party matches one of the other third parties. The set of shared third party data may include completed questionnaires and due diligence reports. The method may further include receiving, from the user, a search query for the first third party from a list of industry members prior to receiving the request to establish an electronic relationship with the first third party.

There is also provided a computer-implemented method of managing third party risk, the method comprising receiving, from a computing device, a request by a user to establish an electronic relationship with a first third party. Possible matches are identified between the first third party and a plurality of other third parties, and the possible matches are provided to the computing device. The user is provided with access to shared third party data of the first third party based on a determination that the first third party is a match with one of the other third parties. A new third party may be created if no possible matches are identified. The method may further include sending requests to the third parties to consent to sharing their information. The third parties may be made searchable after receiving their consent.

There is further provided a computer-implemented method of managing third party risk, the method comprising receiving, from a computing device, a request by a user for a questionnaire to be completed by a third party. The questionnaire is sent to the third party for completion and the completed questionnaire is received from the third party. The completed questionnaire is provided to the user via the computing device. A notification is sent to the computing device if one or more answers provided by the third party in the questionnaire triggers a user-specific flag based on individual perception of risk. The method may further include determining whether the third party has previously completed a questionnaire, and providing the user, via the computing device, with an option to receive the previously completed questionnaire or to request a new questionnaire. The method may further include receiving, from the computing device, a request by the user for clarification on one or more answers provided by the third party. The method may further include requesting consent from the third party to share the answers to the questionnaire with other users.

There is still further provided a computer-implemented method of managing third party risk, the method comprising receiving, from a user, an order for a due diligence report on a third party to evaluate risk presented by the third party. Data corresponding to the order is provided to the server system, including an indication of whether to share the due diligence report with other users. The due diligence report is received from the server system and the server system provides credit points to the user's account if the user indicated to share the due diligence report with other users and other users subsequently purchase the due diligence report. The credit points can be applied towards the cost of ordering future due diligence reports. The method may further include providing the user with an option to order or update an existing due diligence report. The server system may provide credit points to the user's account if other users subsequently purchase the due diligence report updated by the user.

### BRIEF DESCRIPTION OF THE DRAWINGS

FIG. 1 is a schematic diagram of a third party risk management system;

FIG. 2 illustrates a workflow for third party management according to the risk management system of FIG. 1;

FIG. 3 illustrates a workflow for directly adding a third party to a user's third party list;

FIG. 4 illustrates a workflow for adding a third party to the user's third party list by searching for the third party within a list of shared industry members;

FIG. 5 is a screenshot of an example webpage for adding a third party to the user's third party list;

FIG. 6 is a screenshot of an example prompt asking the user to review possible matches between the user's third party and other industry members' third parties;

FIG. 7 is a screenshot of an example webpage for searching for third parties;

FIG. 8 illustrates a workflow for searching for a third party within shared industry members' third parties;

FIG. 9 is a screenshot of an example webpage for viewing and managing the user's third parties;

FIG. 10 is a screenshot of an example dashboard;

FIG. 11 illustrates a workflow for managing the user's profile;

FIG. 12 illustrates a workflow for evaluating third party risk;

FIG. 13 illustrates a workflow for consumption of compliance check services;

FIG. 14 illustrates a workflow for ordering a new questionnaire;

FIG. 15 is a screenshot of an example webpage for loading and ordering a new questionnaire;

FIG. 16 illustrates a workflow for ordering a new due diligence report;

FIG. 17 illustrates a workflow for ordering a shared due diligence report;

FIG. 18 is a screenshot of an example webpage for managing the user's credit points; and

FIG. 19 is a screenshot of an example order page for ordering a due diligence report.

### DESCRIPTION OF SPECIFIC EMBODIMENTS

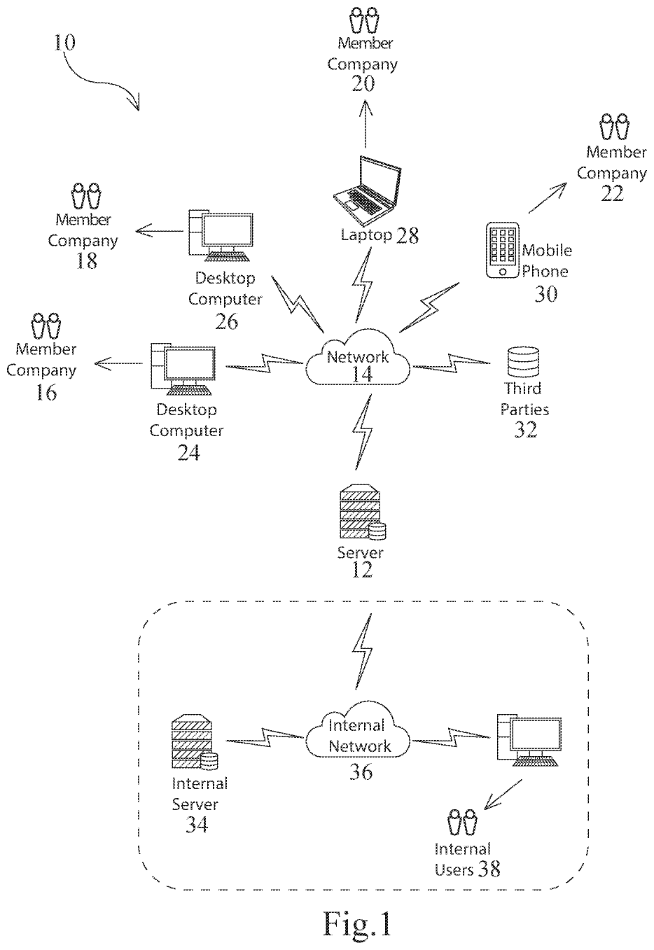

FIG. 1 is a schematic diagram of a risk management system 10 for assisting compliance professionals (industry members) in performing third party due diligence. The risk management system 10 comprises a server 12 which is accessible via a network 14 such as the Internet. Industry members such as construction companies 16 and 18 and technology companies 20 and 22 can communicate with the server 12 over the network 14 via user devices which, in this example, include desktop computers 24 and 26, a laptop 28 and a mobile phone 30. It will be understood by a person skilled in the art that the industry members may be entities from different industries in other examples, and that the user devices may be any suitable device which allows the industry members to connect to the network 14. Third parties 32 can also communicate with the server 12 over the network 14 to provide and modify third party data. The server 12 can access an internal server 34 over an internal network 36 which may be a local access network. Internal users 38 can also access the internal server 34 over the internal network 36.

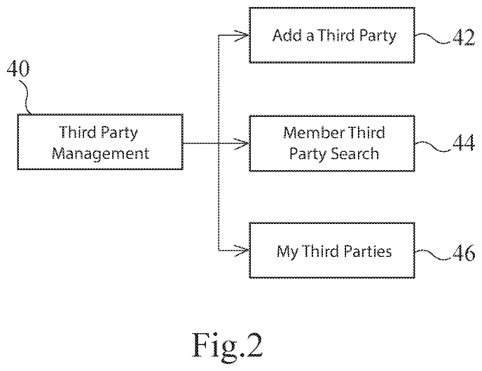

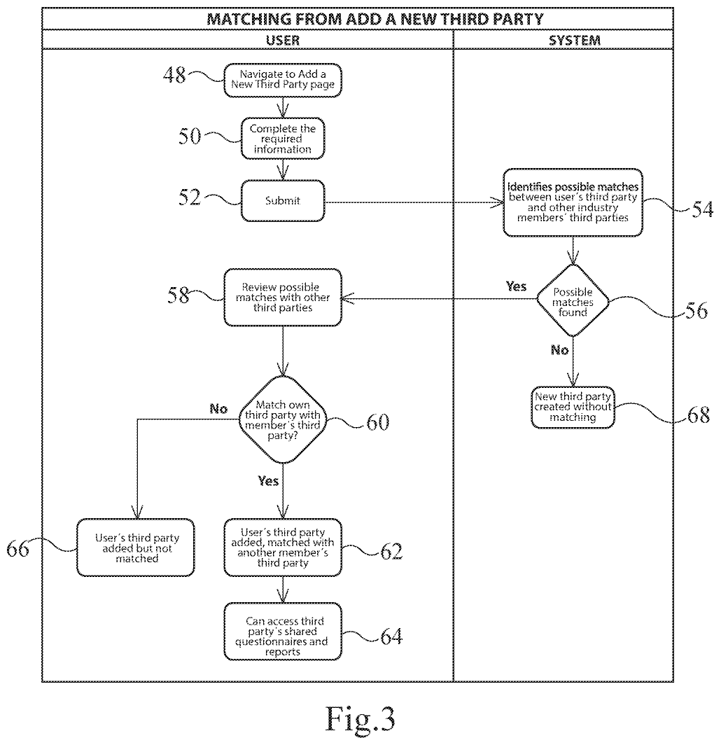

There is a third party management module 40 provided on the server 12 as shown in FIG. 2. The third party management module 40 allows a user to add a third party to their third party list at 42, to search for a third party at 44, and to manage their third parties at 46. As best shown in FIG. 3, the user can directly add a third party to their third party list by navigating to a webpage at step 48. The user completes the required profile information for the third party at step 50 and submits the completed information at step 52. The risk management system then identifies possible matches between the profile of the user's submitted third party and the profiles of other industry members' third parties at step 54. If possible matches are found at step 56, then a list of the possible matches are displayed for the user to review at step 58. If the user confirms at step 60 that their third party is the same as another industry member's third party (i.e., the two third parties are the same entity), then the third party will be added to the user's third party list and the third party will be matched with the other industry member's third party at step 62. This allows the user to access the third party's shared questionnaires and due diligence reports at step 64. However, if the user rejects the possible matches at step 60, then the user's third party is added to the user's third party list without being matched with another industry member's third party at step 66. If no possible matches are found at step 56, then a new profile is created for the user's third party and the third party is added to the user's third party list at step 68.

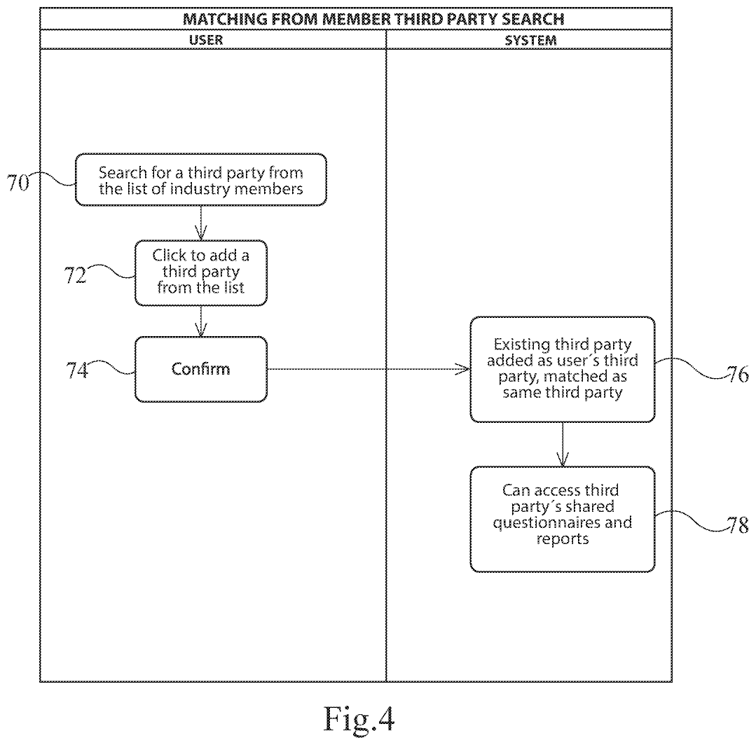

Alternatively, the user can add a third party to their third party list by searching for the third party from a list of industry members as shown at step 70 in FIG. 4. The risk management system will display the information of third parties which have consented to sharing their details with industry members and to making their information searchable. Once the user finds their desired third party, the user can add the third party to their third party list by clicking add at step 72 and confirming at step 74. The third party is then added to the user's third party list and is matched with an existing third party at step 76. This allows the user to access the third party's shared questionnaires and due diligence reports at step 78.

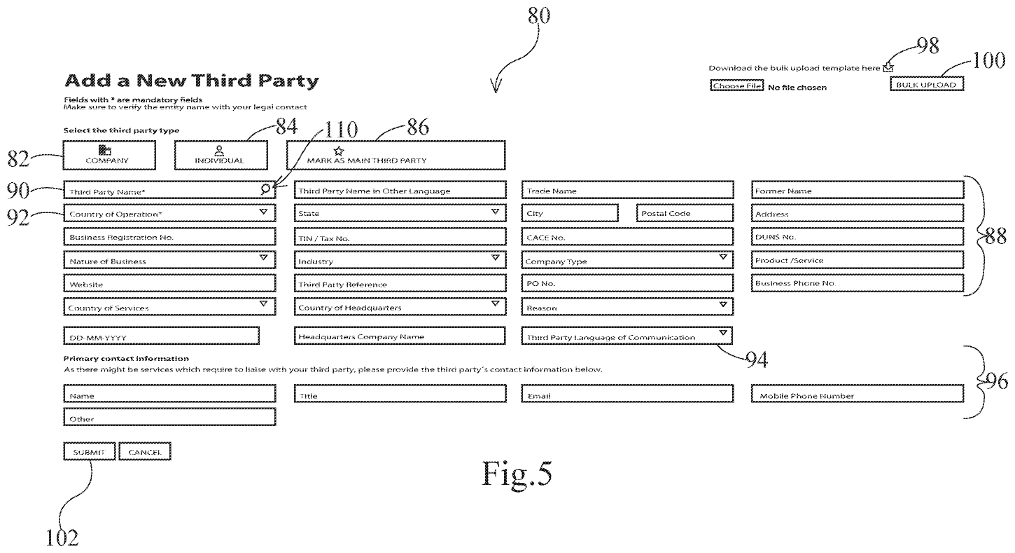

FIG. 5 shows an example webpage 80 for adding a third party to the user's third party list. The user can identify the third party type as a company 82 or an individual 84. The user can also mark a third party as a main third party 86 to distinguish between entities that the user deals with directly as opposed to indirectly. This allows the user to sort their third party list for ordering due diligence reports. There is a plurality of fields 88 for the user to complete with the third party's information. Most of the fields 88 are optional but certain ones may be required, such as the third party's name 90 or the third party's country of operation 92. There may also be the option to add custom fields for additional information. The user can indicate the third party's language of communication 94 so that the risk management system can send third party interactions, such as a code of conduct or questionnaires, in the third party's preferred language. The user can also provide primary contact information 96 for the third party to allow the risk management system to liaise with the third party if necessary. If the user needs to add a large number of third parties, they can download and complete a bulk upload template 98. The template 98 may be a spreadsheet with several mandatory columns for completion. Once the template 98 is completed and saved, it can be uploaded to the risk management system via a bulk upload function 100. When the user is ready to add the third party, they can click a submit button 102.

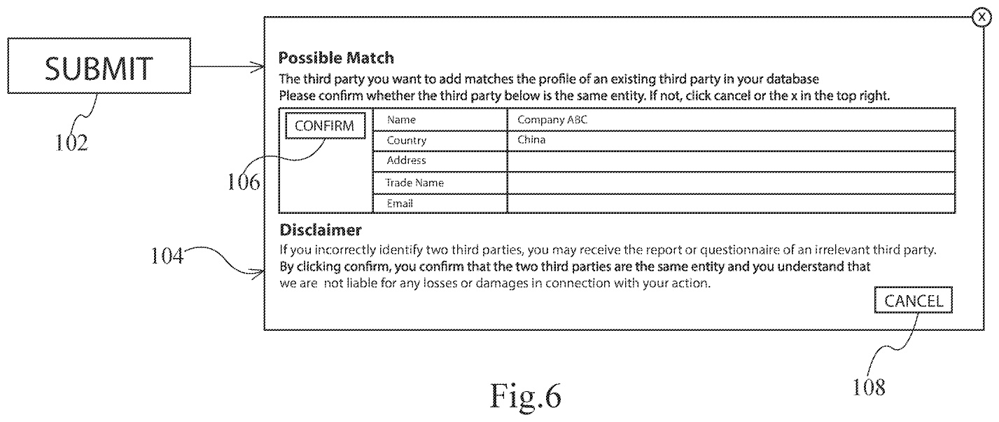

After the user clicks the submit button 102, the risk management system searches the third parties of other industry members to determine if the user's third party is the same entity as a pre-existing third party in the system. FIG. 6 shows an example prompt 104 which asks the user to review any possible matches between the user's third party and another industry member's third party. The user can select confirm 106 to match their third party with another industry member's third party. This enables the user to access the third party's shared questionnaires and due diligence reports, which leads to shorter turnaround times, decreased administrative burden and lower costs. If none of the possible matches are the same as the user's third party, then the user can choose not to match the entities by selecting cancel 108. A new profile is then created for the user's third party.

Referring back to FIG. 5, the user can also use a search function 110 to see if their third party has already been added in order to avoid duplicates. As described above and shown in FIG. 4, if the desired third party is found in the search, then the third party is matched with an existing third party and the third party is added to the user's third party list. Otherwise, if the search does not reveal any matches with an existing third party, a new profile is created for the user's third party.

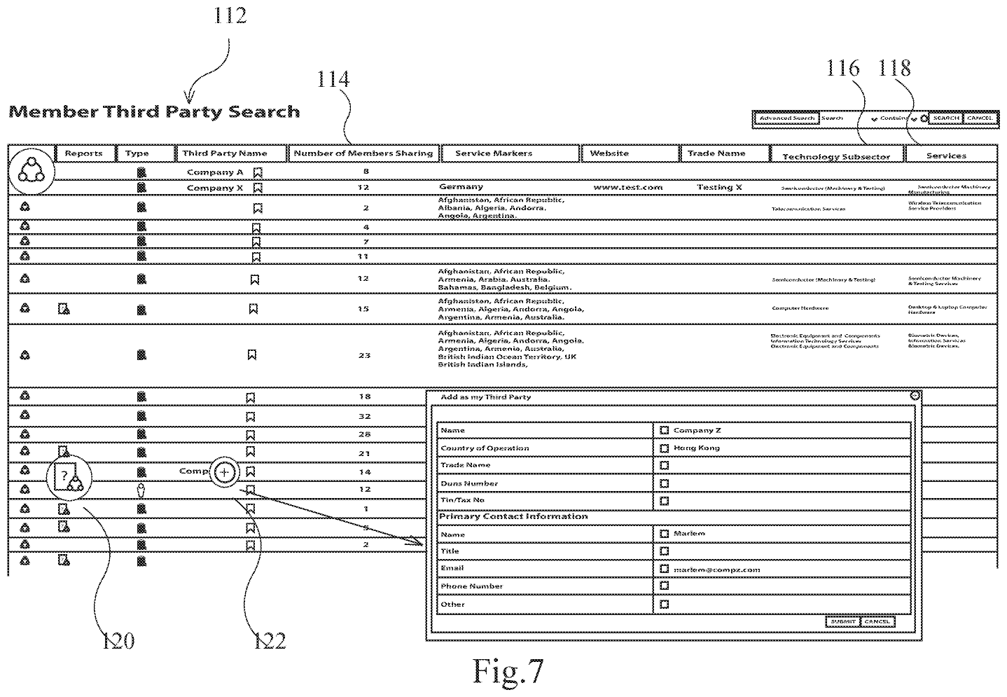

During the search process, the user can see whether a third party has any shared due diligence reports or questionnaires that can be ordered instantly, as well as how many other industry members are sharing the third party. FIG. 7 shows an example webpage 112 for viewing and searching for a third party's information. The user can view the number of industry members 114 sharing the same third party, the third party's technology subsector 116, and the third party's services 118. Any available reports 120 are also visible to the user. The user can also add any of the third parties to their third party lists at 122, thereby allowing the user to access shared due diligence reports and questionnaires. Furthermore, the user can view a third party's sharing history to see which other third parties the third party is matched with, when other industry members matched and unmatched their third parties with the third party, when the third party was added, and when an industry member made any edits to the third party. The user can also unmatch their own third parties from other industry members' third parties if desired.

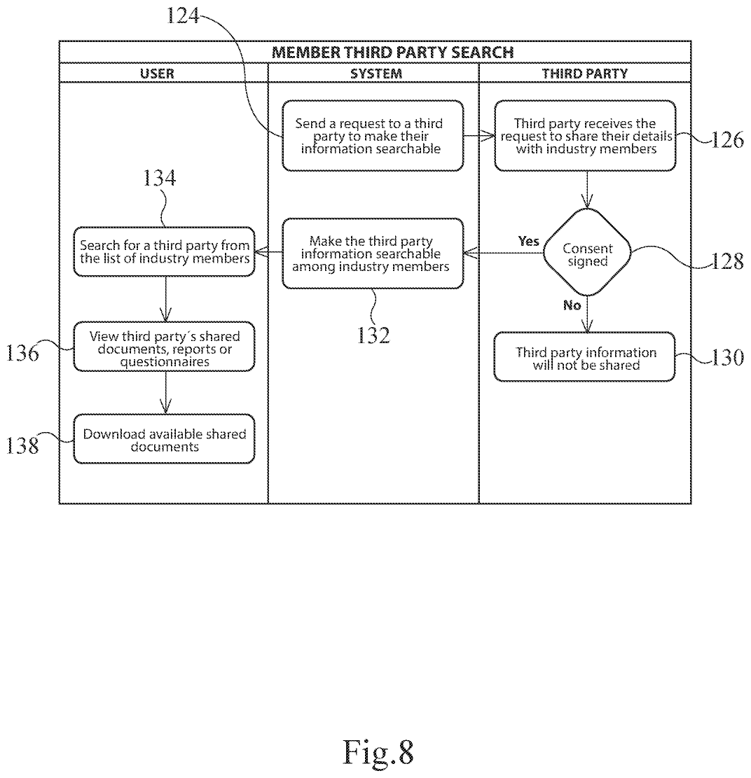

However, the user can only search for third parties that have consented to making their information searchable to industry members. FIG. 8 illustrates the process of obtaining consent from third parties to make their information searchable to industry members. The risk management system first sends a request to a third party to make their information searchable at step 124. The third party receives the request to share their details with industry members at step 126. The third party then has the option to grant or decline consent at step 128. If the third party declines consent, then the third party's information will not be shared at step 130. If the third party grants consent, then the risk management system makes the third party's information searchable among industry members at step 132. This allows the user to search for a third party from a list of industry members at step 134 and to view the third party's shared due diligence reports, questionnaires, or other documents at step 136. The user can also download any available shared documents at step 138.

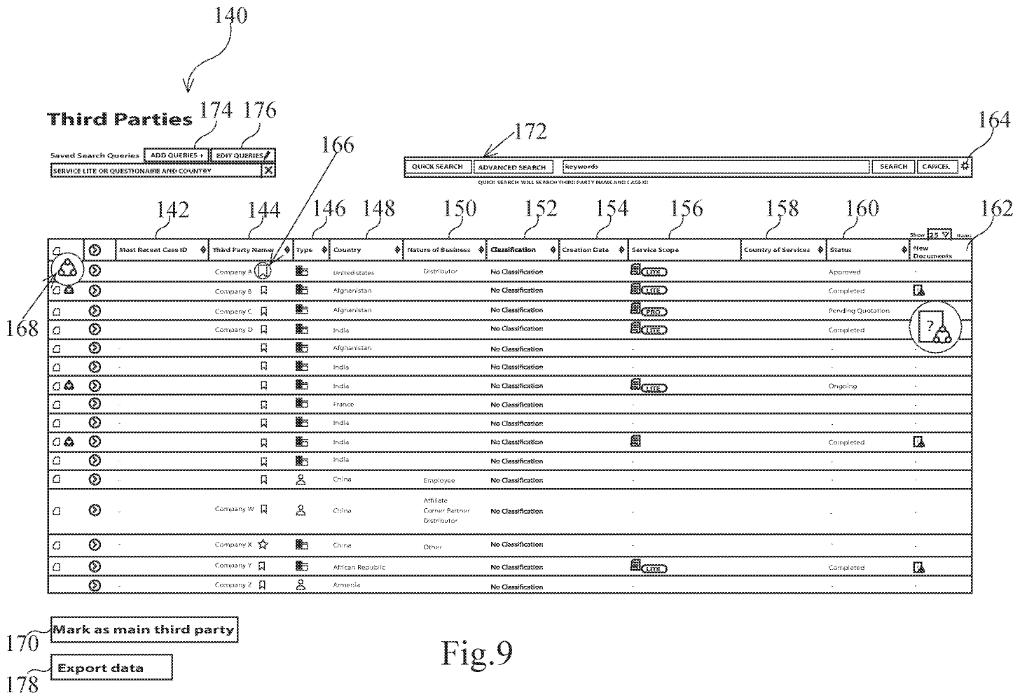

FIG. 9 shows an example webpage 140 which provides the user with an overview of their third parties that have been added to the risk management system. For example, the webpage 140 may show relevant details of each third party such as most recent case ID 142, third party name 144, type 146 (i.e. company or individual), country 148, nature of business 150, classification 152, creation date 154, service scope 156, and country of services 158. Other third party details may include automation stage, automation date, Triage alerts, who handled a Triage alert, risk level, order date, due date, report date, related entities, and case owner. The user can view the current status 160 of reports. The user can also view if their third parties have any shared documents 162 such as due diligence reports or questionnaires. If a third party has available shared documents 162, the user can download the documents. The number of columns displayed for the third parties on the webpage 140 can be adjusted through settings 164.

A third party may have a symbol 166 next to its name to indicate that the third party is shared with at least one other industry member. In this example, the symbol 166 is a ribbon but may be a different shape in other examples. There may be another symbol 168 to indicate whether the user has shared a questionnaire or due diligence report for a particular third party with one or more industry members. A third party can be marked as a main third party by selecting the third party and clicking button 170. The user may wish to mark a third party as a main third party if, for example, the user holds a contract with the third party and will therefore order due diligence reports for the third party. In contrast, a third party may be added but not marked as a main third party if the user does not deal directly with the entity, and thus does not need to order due diligence reports about them, but still requires their information for compliance purposes.

There is a search function 172 which allows the user to search for third parties. The user can customize their search based on a combination of search criteria such as case ID, country, classification, third party name, third party reference, nature of business, service scope, user, type, risk, due date, creation date, order date, report date, status, the user who handled the case internally, by main third party, and by theatre name. Search queries can be added at 174 and saved queries can be edited at 176. Once the user has obtained the desired search results, the user can view the data on the page 140 or export the shown details as raw data at 178. Any third parties found in the search can also be added to the user's third party list if desired.

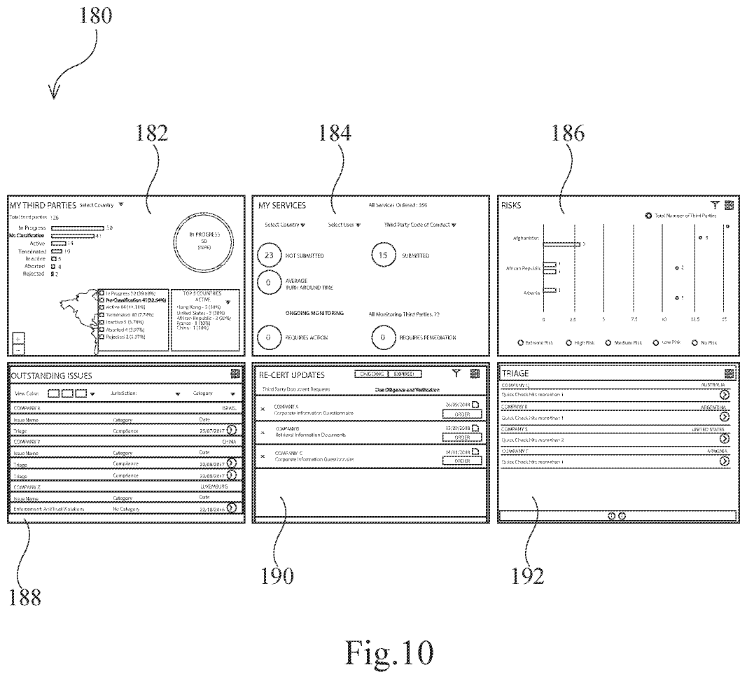

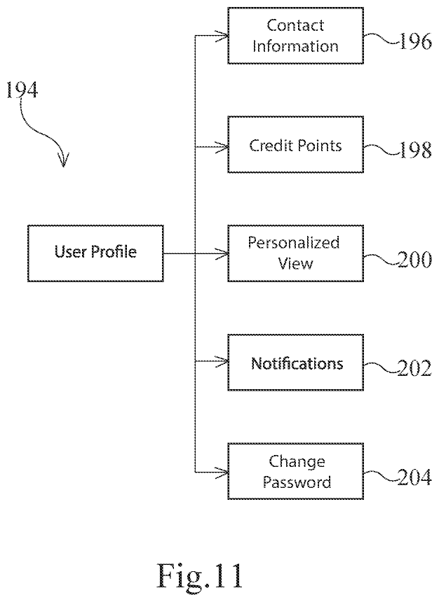

Once the user's third parties have been imported into the risk management system, the user is presented with a comprehensive overview of their third parties after logging in. FIG. 10 shows an example dashboard 180 which is visible to the user after logging into the risk management system. The dashboard 180 may include a plurality of tiles, for example, tiles 182, 184, 186, 188, 190 and 192 each displaying information about the user's third parties. The risk management system also provides the user with settings 194, shown in FIG. 11, to edit their user profile. The settings 194 allow the user to view and/or edit their contact information 196, credit points 198, personalized view 200, notifications 202, and password details 204.

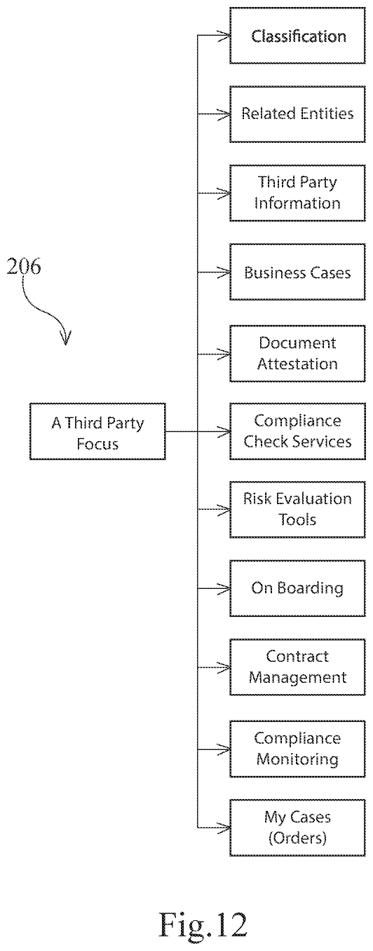

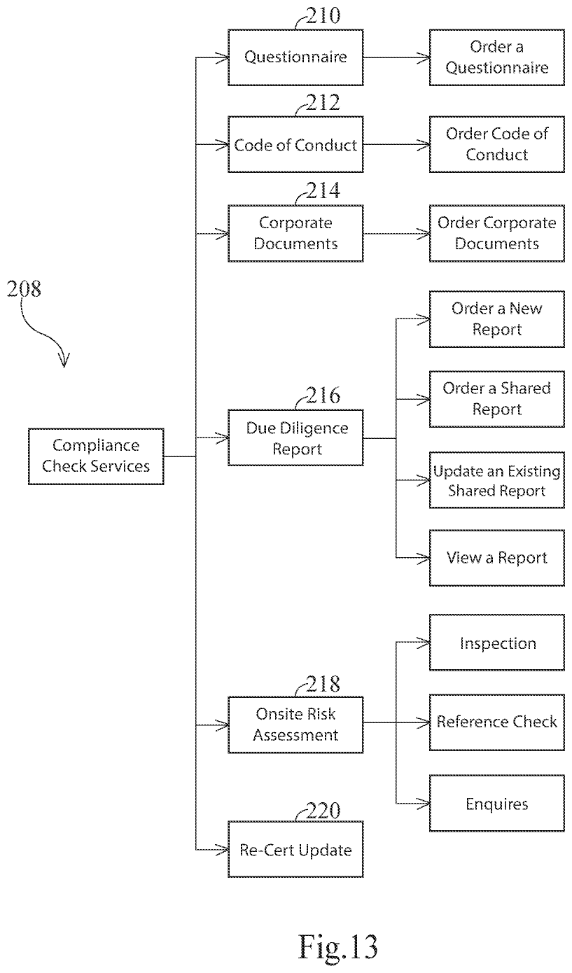

Referring now to FIG. 12, the risk management system includes a set of tools and functionalities that allows the user to evaluate the risk of their third parties through a series of interactions 206. In particular, this is achieved through a list of compliance check services 208 shown in FIG. 13. The compliance check services 208 may include, for example, a questionnaire compliance service 210, a code of conduct service 212, a corporate documents retrieval service 214, a due diligence report ordering service 216, an onsite risk assessment service 218, and a re-certification update service 220.

The questionnaire compliance service 220 allows the user to send a questionnaire to one of their third parties to obtain answers for compliance purposes. Each industry has a default questionnaire, and each user can flag any outcomes of the default questionnaire based on their own perception of risk. This allows for a high degree of risk calibration and customization. The third party's risk level is determined in part by the questionnaire flags set by the user. The third party's risk level in turn determines the next steps taken by the user, such as ordering additional due diligence on third parties that are assessed as high risk. There is also the option for users to use a custom questionnaire. In the case that a third party has provided an answer that triggers a user-specified flag, the risk management system will notify the user by adding a red flag to the Triage tile 192, shown in FIG. 10, and sending an email notification.

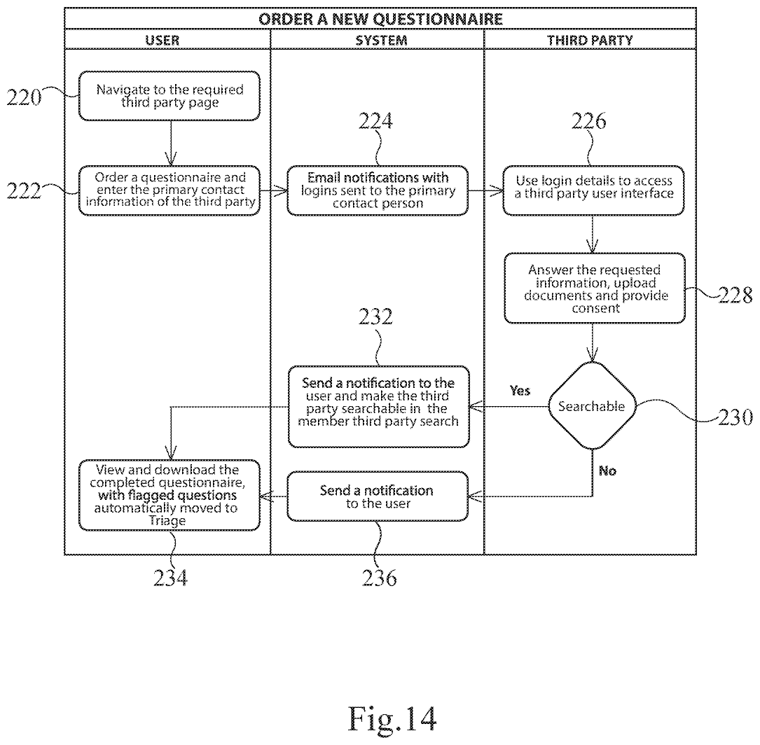

FIG. 14 illustrates the process of ordering a new questionnaire. The user first navigates to the required third party page at step 220. The user then orders a new questionnaire and enters the primary contact information for the third party at step 222. The risk management system sends an email notification with a login prompt to the primary contact person for the third party at step 224. The primary contact person logs into the risk management system on behalf of the third party at step 226 to access a third party user interface. The third party answers the requested information and uploads any documents at step 228. The third party can also consent to a disclaimer, consent to who they want to share their responses with, and consent to becoming searchable at step 230. If the third party consents to becoming searchable, then their information will appear on the third party search page 112 shown in FIG. 7. Referring back to FIG. 14, if the third party provides consent at step 230, then the risk management system makes the third party searchable and sends a notification to the user at step 232. The user can then view and download the completed questionnaire at step 234. Any questionnaire answers which the user has flagged as a risk are automatically moved to the user's Triage tile 192, shown in FIG. 10. Referring back to FIG. 14, if the third party does not consent to becoming searchable at step 230, then the risk management system notifies the user that the questionnaire has been completed at step 236, but does not make the third party searchable. After a questionnaire has been completed by a third party, the user can still request that the third party provide further clarification on their questionnaire answers. Users can send clarification requests and third parties can update their questionnaire response from within the risk management system.

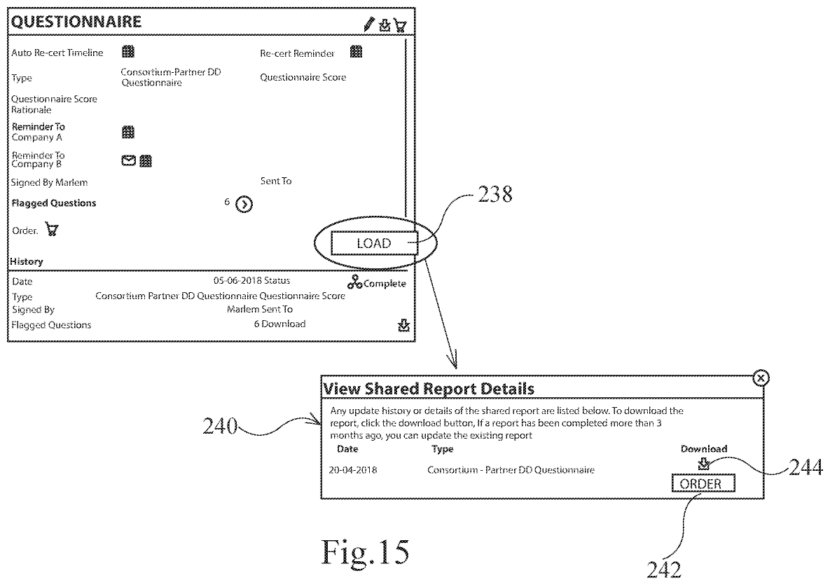

If a third party consents to sharing their questionnaire responses with certain industry members, then those industry members can load the third party's questionnaires immediately into their user account as shown in FIG. 15. By clicking a load button 238, the user can view a third party's shared report details 240. The shared report details 240 indicate which questionnaires have been completed by a third party and shared with the user. If no questionnaires are available, the user can order a new one at 242. If a completed questionnaire is available, the user can download it at 244. Downloaded questionnaires appear in an appropriate one of the tiles on the dashboard 180 shown in FIG. 10. If the user does not have permission to access a third party's questionnaire, they can send a request for the third party to grant them access. Users can also search for a third party that has shared a questionnaire in the same industry, and download the shared questionnaire without adding the third party to their third party list. The risk management system maintains a record of questionnaires which have been ordered. If there is an existing questionnaire for a third party, users can load the questionnaire answers to evaluate the third party's risk directly. Otherwise, users can order a new questionnaire and choose whether or not they want to share the questionnaire with other industry members. Users may be prevented from ordering a new questionnaire for a third party if the third party has completed a previous questionnaire within a recent time period, for example, within the last three months.

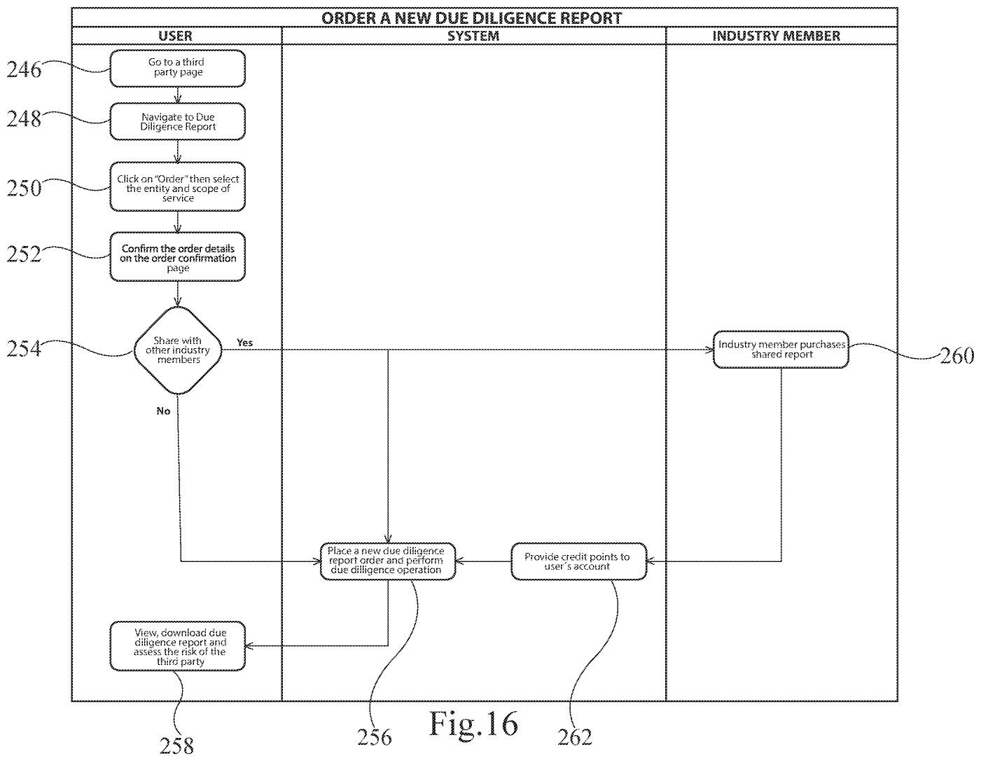

Users can also order due diligence reports to check whether their third parties present risks. Users can order a new due diligence report with a standard turnaround time or an express turnaround time. FIG. 16 shows the process of ordering a new due diligence report. The user goes to a third party page at step 246 and navigates to the due diligence report section at step 248. On the order page, the user selects the desired third party and the scope of service at step 252. The user can also select the third party's subsequent jurisdictions and upload any supporting documents before confirming the order details at step 252. The user then has the option to share the due diligence report with other industry members at step 254. Regardless of whether the user chooses to share the due diligence report, the risk management system will place an order for a new due diligence report and perform a due diligence operation at step 256. The user can then view and download the due diligence report at step 258 to assess the risk of the third party. However, if the user chooses to share the due diligence report with other industry members at step 254, then other industry members can purchase the shared due diligence report at step 260. If another industry member subsequently purchases the user's shared report, then the user receives credit points to their account at step 262.

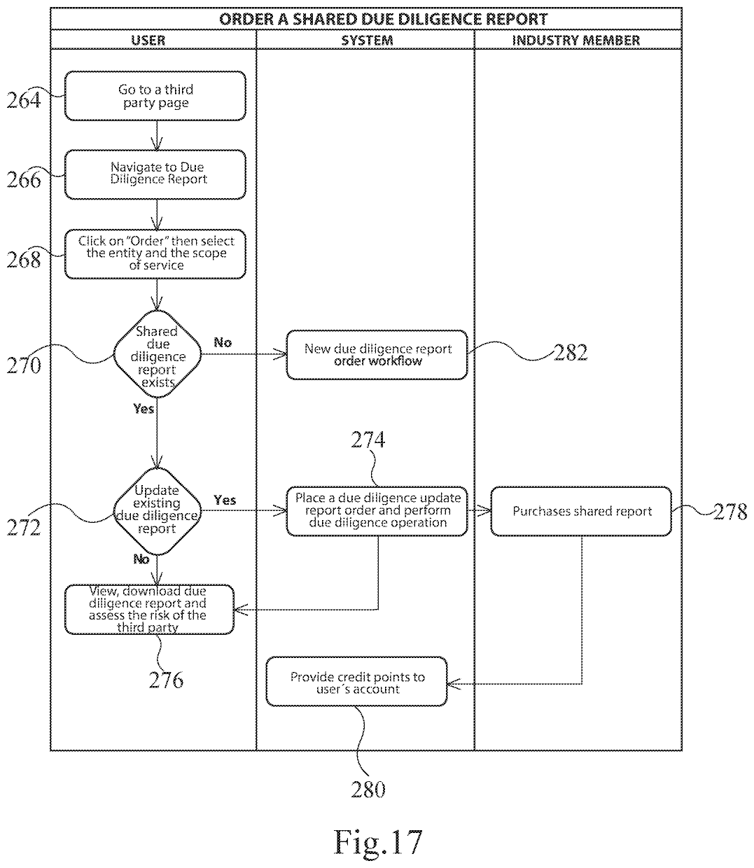

Similarly, if another industry member has ordered and shared a due diligence report for a third party, then any user in the same industry can order the available reports. FIG. 17 shows the process for ordering a shared due diligence report. Similar to ordering a new due diligence report, the user goes to a third party page at step 264, navigates to the due diligence report section at step 266, and selects the third party and the scope of service on the order page at step 268. However, if a shared due diligence report exists for the third party at step 270, then the user has the option to update the existing due diligence report or to order the existing due diligence report at step 272. If the user chooses to update the existing due diligence report, then an order for a due diligence report is placed and the risk management system performs a due diligence operation at step 274. The user can then view and download the due diligence report at step 276 to assess the risk of the third party. If the user chooses to order the existing due diligence report, then the user proceeds directly to step 276 from step 272. If another industry member subsequently purchases the updated due diligence report at step 278, then the user receives credit points to their account at step 280. If a shared due diligence report does not exist for the third party at step 270, then a new due diligence report is ordered at step 282 per the process illustrated in FIG. 16 and described above. Users receive a discount when ordering a shared due diligence report. This results in cost savings and shorter turnaround times.

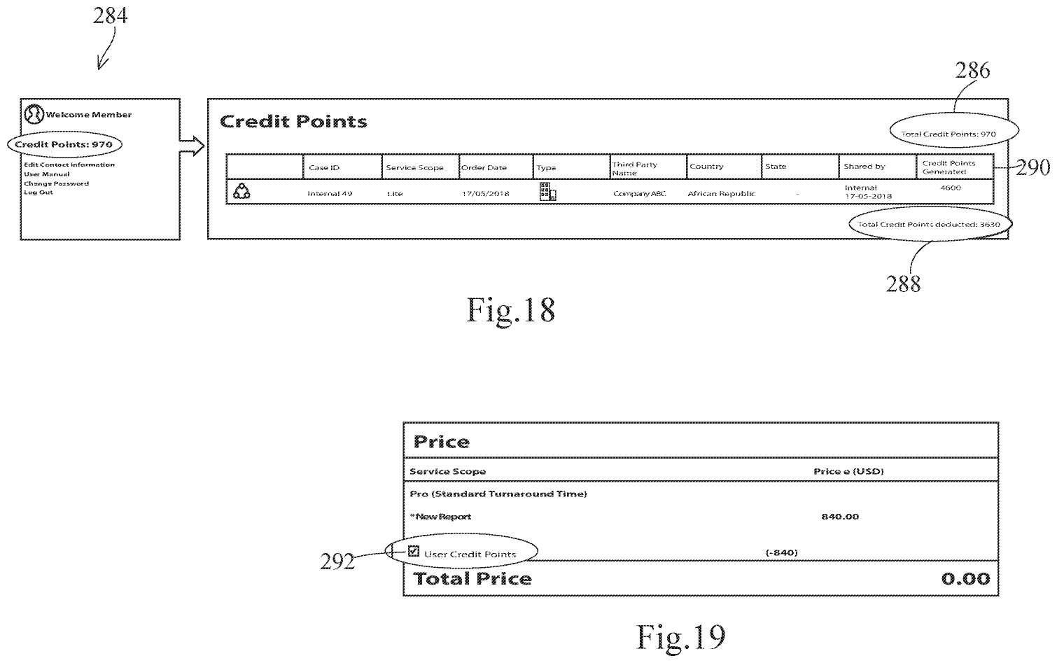

By sharing due diligence reports with other industry members, users can gain credits points that can be used to discount future reports, resulting in cost savings. FIG. 18 shows an example webpage 284 for a user to view their credit point details. The user can view their current credit point balance 286 and the total credit points used 288. The user can also view the credit points generated 290 for each order. When ordering a due diligence report, the user can simply tick a box 292 to use their credit points as shown in FIG. 19.

It will be understood by a person skilled in the art that many of the details provided above are by way of example only, and are not intended to limit the scope of the invention which is to be determined with reference to the following claims.

What is claimed is:

1. A computer-implemented method of managing third party risk, the method comprising:
receiving, from a user, a request to establish an electronic relationship with a first third party to evaluate risk presented by the first third party;
providing data corresponding to the request to a server system;
receiving, from the server system, possible matches between the first third party and a plurality of other third parties;
receiving, from the user, confirmation as to whether the first third party matches one of the other third parties; and
receiving, from the server system, a set of shared third party data provided by the first third party;
wherein the set of shared third party data provided by the first third party is selected by the server system to be delivered to the user only if the user confirms that the first third party matches one of the other third parties.

2. The computer-implemented method of claim 1, further including receiving, from the user, a search query for the first third party from a list of industry members prior to receiving the request to establish an electronic relationship with the first third party.

3. The computer-implemented method of claim 1, wherein the set of shared third party data includes completed questionnaires and due diligence reports.

4. A computer-implemented method of managing third party risk, the method comprising:
receiving, from a computing device, a request by a user to establish an electronic relationship with a first third party;
identifying possible matches between the first third party and a plurality of other third parties;
providing the possible matches to the computing device; and
providing the user with access to shared third party data of the first third party based on a determination that the first third party is a match with one of the other third parties.

5. The computer-implemented method of claim 4, wherein a new third party is created if no possible matches are identified.

6. The computer-implemented method of claim 4, further including sending requests to the third parties to consent to sharing their information and making the third parties searchable after receiving consent.

7. A computer-implemented method of managing third party risk, the method comprising:
receiving, from a computing device, a request by a user for a questionnaire to be completed by a third party;
sending the questionnaire to the third party for completion;
receiving a completed questionnaire from the third party;
providing the completed questionnaire to the user via the computing device; and
sending a notification to the computing device if one or more answers provided by the third party in the questionnaire triggers a user-specific flag based on individual perception of risk.

8. The computer-implemented method of claim 7, further including determining whether the third party has previously completed a questionnaire, and providing the user, via the computing device, with an option to receive the previously completed questionnaire or to request a new questionnaire.

9. The computer-implemented method of claim 7, further including receiving, from the computing device, a request by the user for clarification on one or more answers provided by the third party.

10. The computer-implemented method of claim 7, further including requesting consent from the third party to share the answers to the questionnaire with other users.

11. A computer-implemented method of managing third party risk, the method comprising:
receiving, from a user, an order for a due diligence report on a third party to evaluate risk presented by the third party;
providing data corresponding to the order to the server system, including an indication of whether to share the due diligence report with other users; and
receiving, from the server system, the due diligence report;
wherein the server system provides credit points to the user's account if the user indicated to share the due diligence report with other users and other users subsequently purchase the due diligence report, and wherein the credit points can be applied towards the cost of ordering future due diligence reports.

12. The computer-implemented method of claim 11, further including providing the user with an option to order or update an existing due diligence report, wherein the server system provides credit points to the user's account if other users subsequently purchase the due diligence report updated by the user.
